(19) United States
(12) Patent Application Publication
(10) Pub. No.: US 2025/0045567 A1
(43) Pub. Date: Feb. 6, 2025

(54) SYSTEMS AND METHODS FOR LANGUAGE AGENT OPTIMIZATION

(71) Applicant: Salesforce, Inc., San Francisco, CA (US)

(72) Inventors: Weiran Yao, San Francisco, CA (US); Shelby Heinecke, San Francisco, CA (US); Juan Carlos Niebles Duque, Mountain View, CA (US); Zhiwei Liu, Palo Alto, CA (US); Yihao Feng, Austin, TX (US); Le Xue, Mountain View, CA (US); Rithesh Murthy, San Francisco, CA (US); Zeyuan Chen, Mountain View, CA (US); Jianguo Zhang, San Jose, CA (US); Devansh Arpit, Pacifica, CA (US); Ran Xu, Palo Alto, CA (US); Lik Mui, San Francisco, CA (US); Huan Wang, Palo Alto, CA (US); Caiming Xiong, Menlo Park, CA (US); Silvio Savarese, Palo Alto, CA (US)

(21) Appl. No.: 18/498,257

(22) Filed: Oct. 31, 2023

Related U.S. Application Data
(60) Provisional application No. 63/517,480, filed on Aug. 3, 2023.

(51) Int. Cl. G06N 3/0455; G06N 3/092

(52) U.S. Cl. CPC G06N 3/0455; G06N 3/092

(57) ABSTRACT

Embodiments described herein provide for optimizing a language model (LM) agent. In at least one embodiment, and LM agent comprises an “actor” LM and a “retrospective LM which provides reflections on attempts by the actor LM. The reflections are used to update subsequent prompts to the actor LM. Optimizing the LM agent comprises fine-tuning parameters of the retrospective LM while keeping parameters of the actor LM frozen. A gradient may be determined by a change in reward from the environment based on actions taken by the actor LM with and without a reflection of the retrospective LM. Using this gradient, parameters of the retrospective LM may be updated via backpropagation.

### CROSS REFERENCE(S)

The instant application is a nonprovisional of and claim priority under 35 U.S.C. 119 to U.S. provisional application No. 63/517,480, filed Aug. 3, 2023, which is hereby expressly incorporated by reference herein in its entirety.

### TECHNICAL FIELD

The embodiments relate generally to machine learning systems for artificial intelligence (AI) agents, and more specifically language model agent optimization.

### BACKGROUND

Traditionally, expensive labor and time is used to assist different needs of a user and/or customer, such as customer service, assisted shopping, and/or the like. Some machine learning systems have been used in deploying AI agents to perform tasks including actions performed on an environment (e.g., a shopping website, a customer service tool, and/or the like) through the use of AI agents. However, such AI agents largely lack efficiency and are unable to perform a destined task desired by a user.

### BRIEF DESCRIPTION OF THE DRAWINGS

FIG. 1 is a simplified diagram illustrating an AI agent framework according to some embodiments.

FIG. 2 is a simplified diagram illustrating an exemplary method for rating reflection responses according to some embodiments.

FIG. 3 is a simplified diagram illustrating an exemplary framework for optimizing a retrospective language model according to some embodiments.

FIG. 4A is a simplified diagram illustrating a computing device implementing the AI agent framework described in FIGS. 1-3, according to some embodiments.

FIG. 4B is a simplified diagram illustrating a neural network structure, according to some embodiments.

FIG. 5 is a simplified block diagram of a networked system suitable for implementing the AI Agent framework described in FIGS. 1-3 and other embodiments described herein.

FIG. 6 is an example logic flow diagram illustrating a method of training a neural network based agent based on the framework shown in FIGS. 1-3, according to some embodiments.

FIGS. 7-8 provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. As used herein, the term “language model” (LM) may refer generally to a language model, which may be an LLM, or another language model. In some embodiments, LMs described herein may be LLMs. In some embodiments, LMs described herein may not be considered LLMs. In some embodiments, functions performed as described herein by a LLM may be performed by a LM.

As used herein, the term “prompt” may refer to a specific text or input of other modality (such as audio, video, image, etc.) that is provided to guide a neural network model to generate an output. For example, a prompt may be provided by a host of the neural network model that identifies a type of a task, e.g., “generate a summary of the input text,” “retrieve a document that is relevant to the input query,” and/or the like. For another example, a prompt may be provided by a user (known as “user prompt”) to identify a specific task request, e.g., “write a paragraph about the architecture of a Transformer model,” and/or the like. One or more prompts provided by different parties may be combined and used at inference to guide a neural network mode to generate an output.

### Overview

An AI agent may be deployed to perform a task while interacting with one or more users. For example, an agent presented with the task of “purchase a guitar on the Amazon website” may perform a series of steps interacting with Amazon with the goal of purchasing a guitar. Existing AI gents often inefficiently search the entire space of possible actions for every single action at a time. Such search process may decompose the target task into a series of single actions over multiple timesteps, but each timestep requires a separate prompt for the AI agent to perform each action

For example, in response to a target task of “purchase a guitar on the Amazon website,” the AI agent may first identify available options on Amazon, using a prompt such as “sending a search query of electric query on Amazon.com”; then receive and sort through the received options, using another prompt such as “ranking the search results based on search price,” and on. The search computations may consume significant power and computational resources.

In view of the need for systems and methods to improve AI agent response accuracy and efficiency, embodiments provide an AI agent framework comprising an actor language model together with a retrospective language model to provide performance feedback for the actions predicted by the actor language model, which may be called “Retroformer”. In some embodiments, to complete a target task, the target task may be performed by an actor language model (LM) in a series of actions in multiple timesteps. For example, the actor LM may receive a first prompt to generate and cause the execution of a first action at a first timestep, and then iteratively receive a respective prompt at each following timestep to generate a respective action to be performed at the following timestep. The prompt may be updated at the end of each timestep after executing an action at the respective timestep. In this way, the updated prompt may reflect the current status of task completion. In order to improve performance of the LM as an agent, another language model (a “retrospective” LM) is used to evaluate the performance of the actor LM after a series of actions that supposedly aim at completing the target task have been finished, referred to as an “attempt”. The evaluation output of the retrospective LM is appended to an initial prompt for the actor LM to generate and/or execute the next attempt. After each attempt, the retrospective LM may provide additional reflections to the initial prompt. The reflective text generated by the retrospective LM may be indicative of what the LLM determines to be why the attempt was unsuccessful, suggestions for improvement, etc.

In one embodiment, the retrospective LM may be trained and/or finetuned based on collecting data from trial attempts of the actor LM. For example, a series of input prompts and resulting rewards based on how successfully the prompted task was performed on the environment. One benefit of embodiments described herein is the ability to use different rewards which may be determined in a number of ways. For example a reward may be determined in a manner specific to a certain environment, by a trained reward model, or by a heuristic, etc. The environment may be a website, an application programming interface (API), physical environment, etc. An example of a state is the items and possible actions displayed on a website (e.g., descriptions, input text fields, buttons which may be clicked, etc.). The retrospective language model may be trained by comparing the relative reward score difference with and without the retrospective LM's reflections.

Embodiments described herein provide a number of benefits. For example, the retrospective LM may have fewer parameters than the actor LM, which makes it use fewer memory and computation resources to fine-tune. More accurate results may be obtained by allowing the combination of actor and retrospective models to use multiple refining attempts to reach a correct sequence of actions. The training methods described herein allow for the retrospective model to provide accurate retrospective responses to optimize actor LM prompts. The policy gradient approach described herein allows learning from arbitrary reward signals from diverse environments and tasks. This facilitates the iterative refinement of the retrospective language model while circumventing the need to access the actor model parameters or propagate gradients through it. The use of a separate retrospective model also allows for used of a plug-in module for different types of language models including cloud-hosted LLMs. Therefore, neural network technology in AI agents is improved.

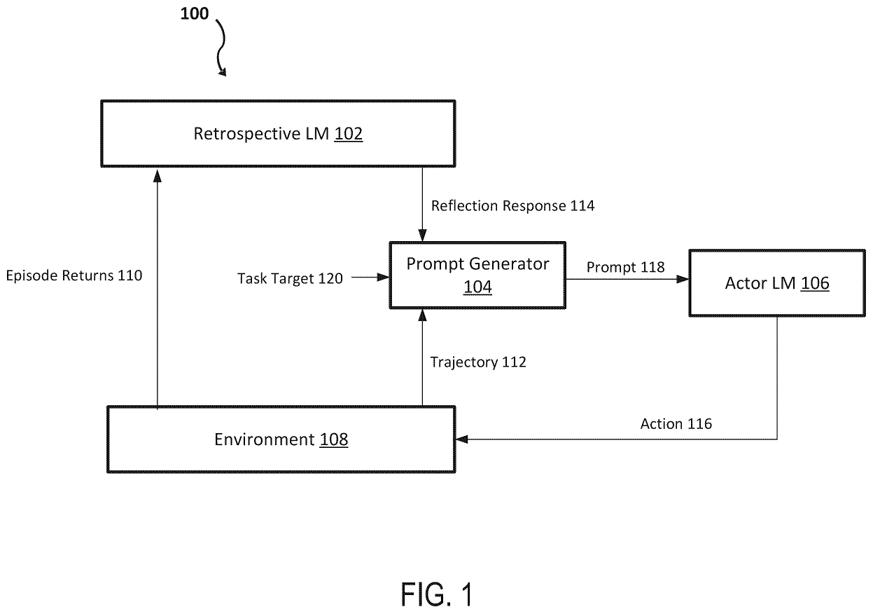

FIG. 1 is a simplified diagram illustrating an AI agent framework 100 according to some embodiments. Framework 100 comprises an actor LM 106, a retrospective LM 102, and a prompt generator 104, which communicatively, jointly and iteratively generate and performs an action upon environment 108.

In one embodiment, the prompt generator 104 receives a task target 120, and through an iterative process actor LM 106 generates actions to be executed on environment 108 which accomplish task target 120. Feedback from environment 108 is used by a retrospective LM 102 to generate reflection responses 114 which are reflective texts used by prompt generator 104 to generate an updated prompt 118, after which the process may repeat and eventually converge on an acceptable sequence of actions 116.

In some embodiments, framework 100 is performed with an inner loop and an outer loop. The inner loop may perform one action 116 at a time, with the prompt generator 104 prompting actor LM 106 via prompt 118 for the next action based on the task target 120 and trajectory 112 and any prior reflection responses 114. After the final action 116 in a set of actions, episode returns 110 may be input to retrospective LM 102 to generate a reflection response 114 to be used in the next set of prompts 118 generated by prompt generator 104 in a subsequent attempt at completing task target 120.

In some embodiments, task target 120 is a user input such as “buy a guitar on Amazon.” In some embodiments, environment 108 may be a web browser, a specific website, an API for interacting with additional software and/or hardware, or the like. The iterative process may include receiving episode returns 110 from environment 108 in response to an action 116 being performed on environment 108. Episode returns may include, for example, an updated state of environment 108, or other outputs of environment 108. Trajectory 112 may also be determined based on outputs of environment 108. Trajectory 112 may represent, for example, the current state after performing the most recently predicted action 116. For example, trajectory 112 may include the available buttons and input fields of a website available after the prior actions. Trajectory 112 may also include prior state information.

In some embodiments, prompt generator 104 iteratively builds a prompt 118 with additional information from each iteration. For example, an initial prompt 118 may include a prompt based on only task target 120. After a first set of actions 116, prompt 118 may be updated to further include a reflection response 114 and a trajectory 112 (i.e., state). In this way, prompt 118 is a form of memory of what occurred in previous attempts by actor LM 106. After a second iteration, prompt generator 104 may further include in prompt 118 the second trajectory 112 and the second reflection response 114. In some embodiments, the prompt 118 iteratively builds without limit. In some embodiments, only a predefined number of the most recent trajectories 112 and/or reflection responses 114 are included in prompt 118. In some embodiments, the amount of trajectories 112 and/or reflection responses 114 included in prompt 118 by prompt generator 104 is limited to a predefined length based on a limitation in input size of actor LM 106. In some embodiments, prompt generator 104 is implemented via a predefined heuristic which concatenates additional state information up to a context size limit. In some embodiments, prompt generator 104 is an LM, which is given an input prompt that causes the LM to generate a summary of prior attempts and include the task target so that information from more attempts may be included in summary form.

For example, an iterative series of prompts 118 may include:
1: [initial prompt]
2: [initial prompt] & [reflection response 1] & [trajectory 1]
3: [initial prompt] & [reflection response 1] & [reflection response 2] & [trajectory 1] & [trajectory 2]
4: [initial prompt] & [reflection response 1] & [reflection response 2] & [reflection response 3] & [trajectory 1] & [trajectory 2] & [trajectory 3]
5: [initial prompt] & [reflection response 2] & [reflection response 3] & [reflection response 4] & [trajectory 2] & [trajectory 3] & [trajectory 4]

Note that these exemplary prompts only demonstrate the update to the prompt 118 at the beginning of each outer loop of a process, and additional prompts 118 may be included prompting for each individual action 116 in a set of actions. Also note that in the fifth exemplary prompt 118, the first reflection response and the first trajectory are dropped due to length constraints.

In some embodiments, retrospective LM 102 is a different language model than actor LM 106. For example, retrospective LM 102 may be a much smaller (i.e., fewer parameters) model than actor LM 106. This may make training and/or fine-tuning of retrospective LM 102 require fewer memory and computation resources. In some embodiments, the parameters of actor LM 106 are fixed, and therefore the actor LM 106 may be considered part of the environment together with environment 108.

In at least one embodiment, the LM based agent, for example as embodied by framework 100, may generate actions to be performed on an environment based on an input target task and environmental context information. For example, the LM based agent may be described as a mapping function [symbol] : [symbol] → [symbol] , where [symbol] is the space of prompts, which may include the actual prompts [symbol] provided by a user, as well as some contextual information c∈ [symbol] . Here [symbol] is the space of context as a representation of current state [symbol] returned by the environment Ω. [symbol] is the space of actions. [symbol] may be characterized as a random function, the subscript ξₗ denotes the re-parameterized random variables involved in the sampling process. In some embodiments, the only memory of the LM agent is in the prompt.

In at least one embodiment, environment 108 may produce an output state based on an input action. For example, an action of clicking the “checkout” button for an e-commerce environment may cause environment 108 to provide a state describing a checkout web page. Environment 108 may be defined as a tuple ( [symbol] , [symbol] ), [symbol] : [symbol] × [symbol] → [symbol] is the state transition function, where S is the space of states and [symbol] is the action space. In some embodiments, it is assumed that the states and actions are represented using text. ξ₀ represents the randomness involved in the state transition.

For each state s E S, a reward function is defined as [symbol] : [symbol] → [symbol] . At each step of the play, the state s is described using natural language, and integrated into the context c. In the context, previous states may also be described and embedded to help the actor LM 106 make a good prediction of the correct next action to take. The final goal is to maximize the cumulative rewards, or returns [symbol] =Σₜ₌₀^{T}R(sₜ). In many situations, the rewards are sparse, i.e., R(sₜ) are mostly zero except a few states.

Retrospective LM 102 takes all the previous states s₁, . . . , sₜ, actions a₁, . . . , aₜ, rewards r₁, . . . , rₜ, and the user prompt mu as input, and adapt them into a new prompt 118 m to be input to the actor LM 106, which may be represented as:

$${Γ}_{{ξ}_{r} , Θ} {: [ {𝒮}_{i} , {𝒜}_{i} , {ℛ}_{i} , {ℳ}_{i}^{u} ]}_{i = 1}^{t} \to ℳ \qquad ( 1 )$$

Where ξᵣ stands for the randomness involved in retrospective LM 102, and Θ is the set of learnable parameters in retrospective LM 102. The goal of the reinforcement learning (RL) optimization is

$$arg max ( Θ ) {𝔼}_{{ξ}_{l} , {ξ}_{0} , {ξ}_{r}} [ {\sum }_{t = 1}^{T} R ( {s}_{t} ) ]$$

$$s . t .$$

$${s}_{t + 1} = {T}_{{ξ}_{0}} ( {s}_{t} , {ℒ}_{{ξ}_{l}} ∘ {Γ}_{{ξ}_{r}} ( {[ {s}_{i} , {a}_{i} , {r}_{i} , {m}_{i}^{u} ]}_{i = 1}^{t} ) ) , \qquad ( 2 )$$

$$∀ t ∈ \{ 1 , … , T - 1 \}$$

In some embodiments, the only learnable parameters are in the retrospective LM 102 [symbol] . Sine the actor LM 106 has fixed parameters, it can be considered as a component of the environment together with environment 108. The combined environment may be represented with the transition function [symbol] = [symbol] ( [symbol] ,•)∘ [symbol] : [symbol] × [symbol] → [symbol] . Using the same reward function R with the combined transition function, then the objective in equation (2) may be treated as a reinforcement learning optimization.

The actor LM 106 may be represented as a function which determines an action based on a current policy π_{θ} at a time step t with an observation sₜ from environment 108 represented as:

$${a}_{k , i , t} = {ℳ}_{a} ( {[ {s}_{k , i , τ} , {a}_{k , i , τ} , {r}_{k , i , τ} ]}_{τ = 1}^{t - 1} , {s}_{k , i , t} ) \qquad ( 3 )$$

The retrospective LM 102 may be represented as a function which determines a reflection response 114 y based on operating under a sparse reward signal, such as binary success status (success/failure) considering the current trajectory alongside its persistent memory.

$${y}_{k , i} = {ℳ}_{r} ( {[ {s}_{k , i , τ} , {a}_{k , i , τ} , {r}_{k , i , τ} ]}_{τ = 1}^{T} , {G}_{k , i} ) \qquad ( 4 )$$

Where ([s_{k,i,τ},a_{k,i,τ},r_{k,i,τ}]_{τ=1}^{T}, G_{k,i} represents a reflection response 114 x_{k,i} and the self reflection feedback y_{k,i} is appended to prompt 118 to prevent repetitive errors in a specific environment 108 in future attempts. Consider a multi-step task, wherein the agent failed in the prior trial. In such a scenario, the retrospective model can detect that a particular action, denoted as aₜ, led to subsequent erroneous actions and final failure. In future trials, the actor LM 106 can use these self-reflections, which are appended to prompt 118, to adapt its reasoning and actions 116 at time t, opting for the alternative action a′ₜ. This iterative process empowers the agent to exploit past experiences within a specific environment and task, thereby avoiding repetitive errors.

In equations (3) and (4), k represents a task, i represents a trial, and t represents the trajectory 112 of the current episode i, and may be considered a form of short-term memory for decision making an reasoning by actor LM 106. The reflection responses 114 may be considered a form of long-term memory as they may summarize prior failed attempts, and those summaries may be appended to prompt 118.

To facilitate policy optimization, prompts 118 and reflection responses 114 may be stored for a number of trials as instruction-response pairs, together with the episode returns in a local dataset, i.e., a “replay buffer.” Samples from the replay buffer may be used to reinforce the retrospective LM 102 at the end of each episode. The long and short-term memory components provide context that is specific to a given task over several failed trials and the replay buffer provides demonstrations of successful reflection responses 114 across the tasks and environments, so that the framework 100 not only exploits lessons learned over failed trials in this task, but also explores by learning from successful reflections in other tasks. The replay buffer may be represented as: D_{RL} which stores the triplets (x_{k,i},y_{k,i},G_{k,i}) of the reflection prompt x_{k,i}, reflection response y_{k,i}, and episode return G_{k,i} of trial i and task k.

Reward shaping may be applied to the binary rewards for obtaining more information. For question answering tasks, instead of exactly matching the answer, a score grading (e.g., f1 score) may be used to evaluate the alignment of the generated output with the expected answer as the reward function.

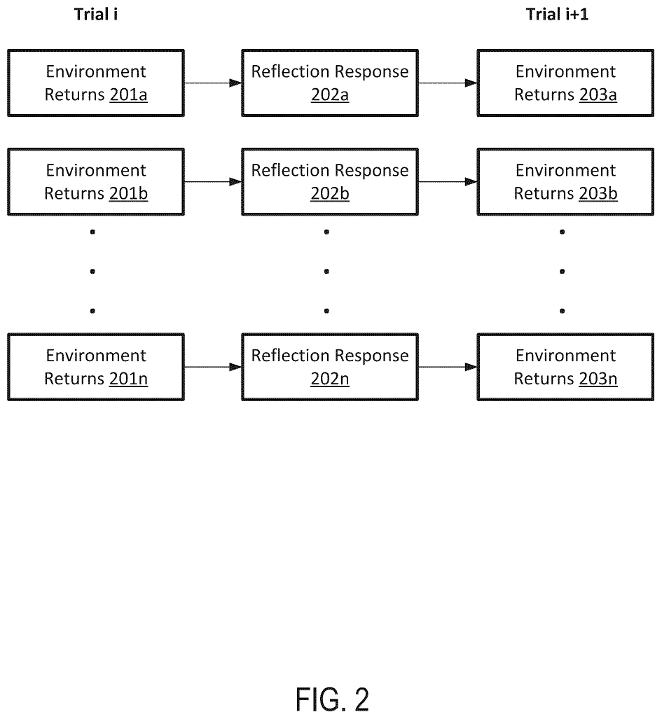

FIG. 2 is a simplified diagram illustrating an exemplary method for rating (i.e., determine a reward for) reflection responses according to some embodiments. In some embodiments, each environment return 201 or 203 is associated with a reward score. The environment return reward scores may be provided by the environment 108, annotated by a person, or determined via a reward model based on the environment 108 state. The change in reward associated with each environment return (e.g., from environment return 201a to environment return 203a) is assumed to be the result of the intervening reflection response (e.g., reflection response 202a) and therefore an improvement in the reward score associated with the environment returns may be used as a reward score associated with the reflection response. By collecting environment returns during trial attempts as described with respect to FIG. 1, the collected data may be used in fine-tuning the retrospective LM 102.

actor LM 106 has a temperature T, which controls the randomness of the output of actor LM 106, set to 0. This means that the model itself does not inject randomness into its outputs, so that the same prompt always generates the same output given a set of parameters. Any change in output is then a results of a change to the input (i.e., prompt 118). An improvement in a return from environment 108 may be used as a reward for rating the quality of a reflection response 114. For example, environment return 201a from a trial i may be used as a baseline, and reflection response 202a which is generated after trial i results in environment returns 203a in trial i+1. Environment returns 203a may be compared to environment returns 201a in order to rate the quality of reflection response 202a. This may be repeated for a number of different groups of environment returns 201b-201n, reflection responses 202b-202n, and corresponding environment returns 203b-203n to provide ratings for reflection responses 202b-202n that may be used in optimizing retrospective LM 102.

For example, assume a reflection response 114 x_{k,i} and the corresponding episode return G_{k,i}, and the retrospective LM 102 [symbol] generates the response y_{k,i} that summarizes the mistakes in i, which results in the return [symbol] in the next attempt i+1. In some embodiments, the actor LM 106 has frozen parameters, and the “temperature” of LM 106 is set to zero, i.e., T=0 meaning the model returns the same output for the same input each time. The injected randomness that leads to differences in returns ΔG_{k,i}=G_{k,i+1}−G_{k,i} are from the reflection responses y_{k,i}, in which positive ΔG_{k,i} indicates better responses that help the actor LM 106 learn from prior errors, and hence should be rated with higher scores. Negative or zero ΔG_{k,i} indicates worse responses that need to be avoided and hence should be rated with lower scores. In some embodiments, a rating score is a reflection of instruction-response pair (x_{k,i},y_{k,i}) represented as:

$$r ( {x}_{k , i} , {y}_{k , i} ) {=}^{△} {G}_{k , i + 1} - {G}_{k , i} \qquad ( 5 )$$

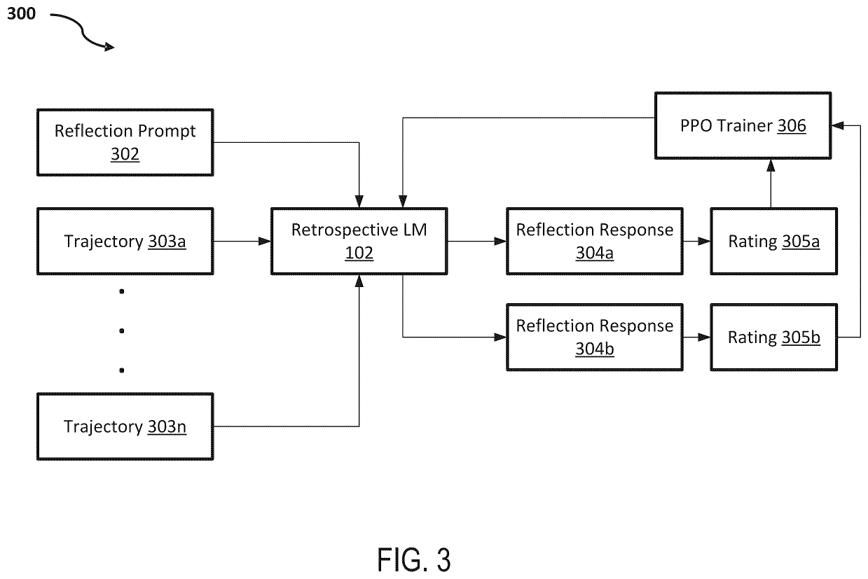

FIG. 3 is a simplified diagram illustrating an exemplary framework 300 for optimizing a retrospective language model according to some embodiments. Framework 300 may use reflection response ratings (e.g., as described in FIG. 2) to optimize the retrospective LM 102. Retrospective LM 102 may receive a reflection prompt 302, and trajectories 303a-303n which include state information based on actions take on an environment, for example as described in FIG. 1. Based on these inputs, retrospective LM generates reflection responses such as reflection response 304a and reflection response 304b. Reflection responses 304a and 304b may receive a rating based on their performance when used, for example as described in FIG. 2. Rating 305a may correspond to reflection response 304a, and rating 305b may correspond to reflection response 304b. The ratings may be used by a proximal policy optimization (PPO) trainer 306. PPO trainer 306 may generate a loss which is used to update parameters of retrospective LM 102 via backpropagation. For example. The loss objective of PPO trainer 306 may be represented as:

$${ℒ}_{PPO} = {𝔼}_{x ∼ {D}_{RL}} {𝔼}_{y ∼ {LLM}_{ϕ}^{RL} ( x )} [ r ( x , y ) - β log \frac{{LLM}_{ϕ}^{RL} ( y \vert x )}{{LLM}^{Ref} ( y \vert x )} ] \qquad ( 6 )$$

Where (x,y) are sampled from the replay buffer, r(x,y) is the defined reward model, and the second term in this objective is the KL divergence to make sure that the fine-tuned model LLM^{RL} does not stray too far from a frozen reference model LLM^{Ref}. For example, in at least one embodiment, an initial language model is used as a starting point for fine-tuning the retrospective LM 102. The initial language model is maintained as a frozen reference model. While training the retrospective LM 102, the frozen reference model is used to evaluate the likelihood of the generated text from the fine-tuned during training, for estimating the KL divergence, which is added to the loss function, so that the fine-tuned retrospective LM 102 does not stray too far from the frozen reference model during training.

The actor LM 106 and retrospective LM 102, and the policy gradient optimization module work together through trials in a loop until the environment deems τₜ to be correct. In some embodiments, offline reinforcement learning methods may be used instead of online optimization. For example, a dataset D_{RL} may be collected by rolling out a base policy, i.e., the frozen actor LM and the initialized retrospective LM, in the tasks in the training sets for N trials and compute the ratings. In some embodiments a reinforcement learning from human feedback (RLHF) pipeline may be used to fin-tune the retrospective model offline before evaluating the agent in the validation tasks. In online execution, a best-of-n sampler may be used, with the scores evaluated by the learned reward model from the RLHF pipeline, as an alternative or additional method of generating better retrospective responses in each trial.

### Computer and Network Environment

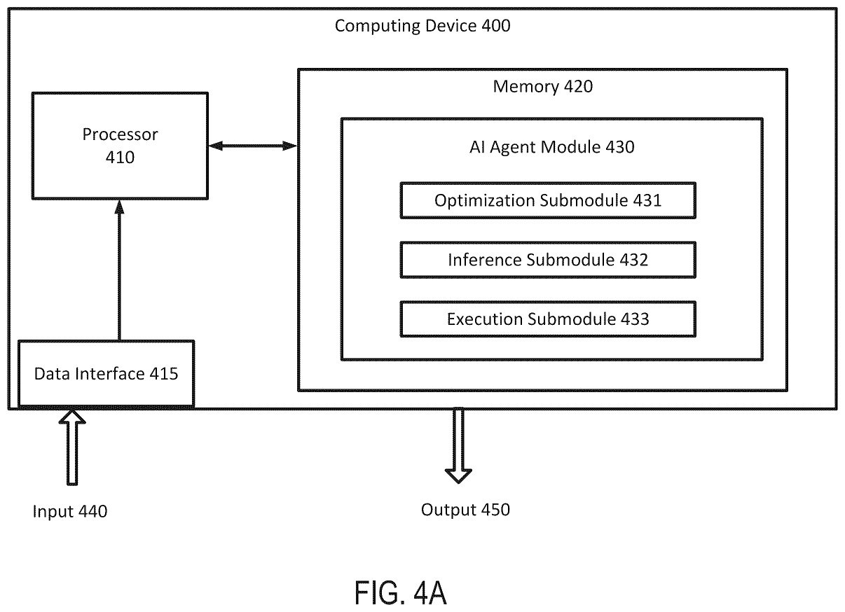

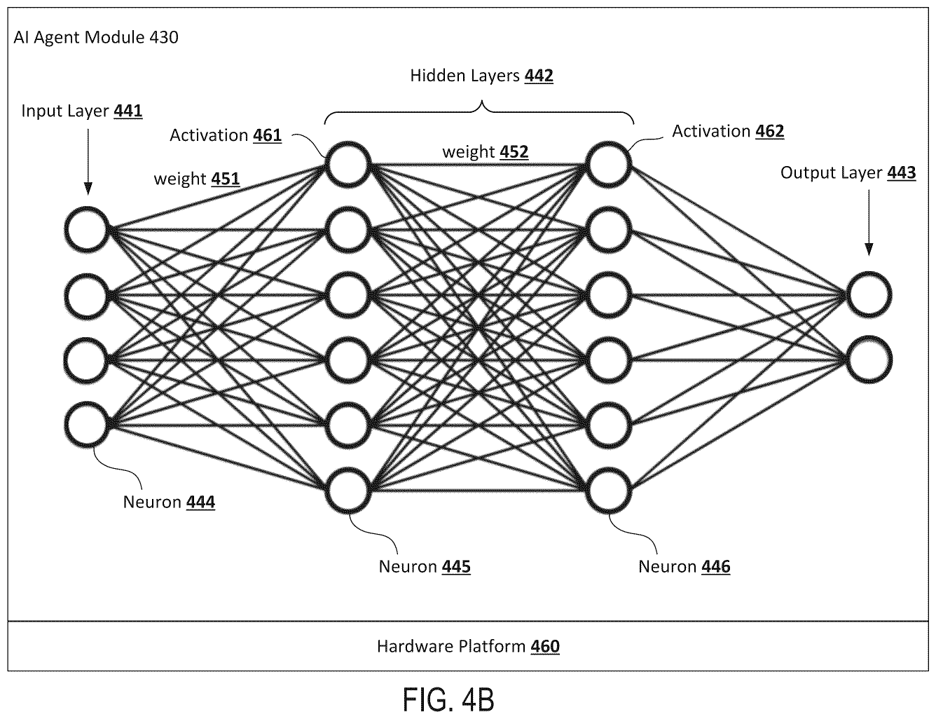

FIG. 4A is a simplified diagram illustrating a computing device implementing the AI agent framework described in FIGS. 1-3, according to one embodiment described herein. As shown in FIG. 4A, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for AI agent module 430 that may be used to implement and/or emulate the systems and models, and/or to implement any of the methods described further herein. AI agent module 430 may receive input 440 such as an input training data (e.g., task prompts, known-good action sequences, or known-good results of a correct action sequence) via the data interface 415 and generate an output 450 which may be a sequence of actions or the execution of those actions.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as task targets, from a user via the user interface.

In some embodiments, the AI agent module 430 is configured to determine actions based on a task target. AI agent module 430 may further include optimization submodule 431. Optimization submodule 431 may be configured to optimize a retrospective LM, for example as described in FIGS. 2-3. AI agent module 430 may further include optimization submodule 432. Inference submodule 432 may be configured to use an actor LM together with a retrospective LM to generate sequences of actions to accomplish a task target on an environment, for example as described in FIG. 1. AI agent module 430 may further include an execution submodule 433. Execution submodule 432 may be configured to cause selected actions to be performed on an environment (e.g., environment 108 in FIG. 1).

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 4B is a simplified diagram illustrating the neural network structure implementing the AI agent module 430 described in FIG. 4A, according to some embodiments. In some embodiments, the AI agent module 430 and/or one or more of its submodules 431-433 may be implemented at least partially via an artificial neural network structure shown in FIG. 4B. The neural network comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., 440 in FIG. 4A), such as prompts. The number of nodes (neurons) in the input layer 441 may be determined by the dimensionality of the input data (e.g., the length of a vector of text). Each node in the input layer represents a feature or attribute of the input.

The hidden layers 442 are intermediate layers between the input and output layers of a neural network. It is noted that two hidden layers 442 are shown in FIG. 4B for illustrative purpose only, and any number of hidden layers may be utilized in a neural network structure. Hidden layers 442 may extract and transform the input data through a series of weighted computations and activation functions.

For example, as discussed in FIG. 4A, the AI agent module 430 receives an input 440 of a task target and transforms the input into an output 450 of a sequence of actions. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the AI agent module 430 and/or one or more of its submodules 431-433 may comprise the transformative neural network structure of layers of neurons, and weights and activation functions describing the non-linear transformation at each neuron. Such a neural network structure is often implemented on one or more hardware processors 410, such as a graphics processing unit (GPU). An example neural network may be a large language model, and/or the like.

In one embodiment, the AI agent module 430 and its submodules 431-433 may be implemented by hardware, software and/or a combination thereof. For example, the AI agent module 430 and its submodules 431-433 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

In one embodiment, the neural network based AI agent module 430 and one or more of its submodules 431-433 may be trained by iteratively updating the underlying parameters (e.g., weights 451, 452, etc., bias parameters and/or coefficients in the activation functions 461, 462 associated with neurons) of the neural network based on a loss objective. For example, during forward propagation, the training data such as task target prompts and associated actions are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth” such as the corresponding ground truth sequence of actions) from the training data, to compute a loss function that measures the discrepancy between the predicted output and the expected output. Given the loss, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

Parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as new tasks.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

Therefore, the training process transforms the neural network into an “updated” trained neural network with updated parameters such as weights, activation functions, and biases. The trained neural network thus improves neural network technology in AI agents.

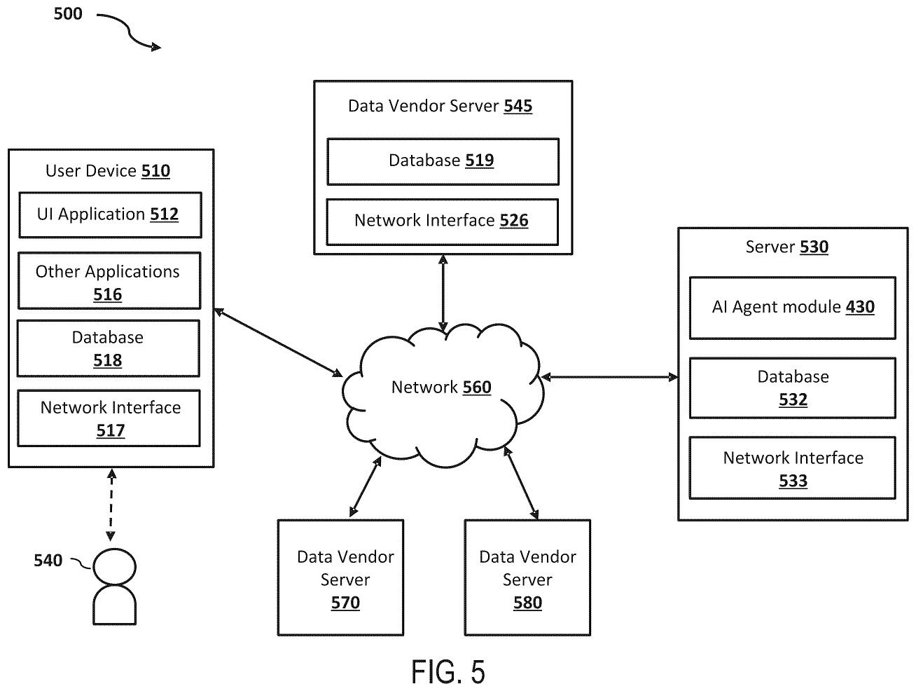

FIG. 5 is a simplified block diagram of a networked system 500 suitable for implementing the AI agent framework described in FIGS. 1-3 and other embodiments described herein. In one embodiment, system 500 includes the user device 510 which may be operated by user 540, data vendor servers 545, 570 and 580, server 530, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4A, operating an OS such as a MICROSOFT® OS, a UNIX® OS, a LINUX® OS, or other suitable device and/or server-based OS. It can be appreciated that the devices and/or servers illustrated in FIG. 5 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 510, data vendor servers 545, 570 and 580, and the server 530 may communicate with each other over a network 560. User device 510 may be utilized by a user 540 (e.g., a driver, a system admin, etc.) to access the various features available for user device 510, which may include processes and/or applications associated with the server 530 to receive an output data anomaly report.

User device 510, data vendor server 545, and the server 530 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 500, and/or accessible over network 560.

User device 510 may be implemented as a communication device that may utilize appropriate hardware and software configured for wired and/or wireless communication with data vendor server 545 and/or the server 530. For example, in one embodiment, user device 510 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 510 of FIG. 5 contains a user interface (UI) application 512, and/or other applications 516, which may correspond to executable processes, procedures, and/or applications with associated hardware. For example, the user device 510 may receive a message indicating a sequence of actions and/or the results of executing actions on an environment from the server 530 and display the message via the UI application 512. In other embodiments, user device 510 may include additional or different modules having specialized hardware and/or software as required.

In various embodiments, user device 510 includes other applications 516 as may be desired in particular embodiments to provide features to user device 510. For example, other applications 516 may include security applications for implementing client-side security features, programmatic client applications for interfacing with appropriate application programming interfaces (APIs) over network 560, or other types of applications. Other applications 516 may also include communication applications, such as email, texting, voice, social networking, and IM applications that allow a user to send and receive emails, calls, texts, and other notifications through network 560. For example, the other application 516 may be an email or instant messaging application that receives a prediction result message from the server 530. Other applications 516 may include device interfaces and other display modules that may receive input and/or output information. For example, other applications 516 may contain software programs for asset management, executable by a processor, including a graphical user interface (GUI) configured to provide an interface to the user 540 to view provided data.

User device 510 may further include database 518 stored in a transitory and/or non-transitory memory of user device 510, which may store various applications and data and be utilized during execution of various modules of user device 510. Database 518 may store user profile relating to the user 540, predictions previously viewed or saved by the user 540, historical data received from the server 530, and/or the like. In some embodiments, database 518 may be local to user device 510. However, in other embodiments, database 518 may be external to user device 510 and accessible by user device 510, including cloud storage systems and/or databases that are accessible over network 560.

User device 510 includes at least one network interface component 517 adapted to communicate with data vendor server 545 and/or the server 530. In various embodiments, network interface component 517 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 545 may correspond to a server that hosts database 519 to provide training datasets including task prompts and action sequences to the server 530. The database 519 may be implemented by one or more relational database, distributed databases, cloud databases, and/or the like.

The data vendor server 545 includes at least one network interface component 526 adapted to communicate with user device 510 and/or the server 530. In various embodiments, network interface component 526 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 545 may send asset information from the database 519, via the network interface 526, to the server 530.

The server 530 may be housed with the AI agent module 430 and its submodules described in FIG. 4A. In some implementations, AI agent module 430 may receive data from database 519 at the data vendor server 545 via the network 560 to generate action sequences and/or results of executing actions on an environment. The generated actions may also be sent to the user device 510 for execution and/or review by the user 540 via the network 560.

The database 532 may be stored in a transitory and/or non-transitory memory of the server 530. In one implementation, the database 532 may store data obtained from the data vendor server 545. In one implementation, the database 532 may store parameters of the AI agent module 430. In one implementation, the database 532 may store previously generated actions, and the corresponding input feature vectors.

In some embodiments, database 532 may be local to the server 530. However, in other embodiments, database 532 may be external to the server 530 and accessible by the server 530, including cloud storage systems and/or databases that are accessible over network 560.

The server 530 includes at least one network interface component 533 adapted to communicate with user device 510 and/or data vendor servers 545, 570 or 580 over network 560. In various embodiments, network interface component 533 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 560 may be implemented as a single network or a combination of multiple networks. For example, in various embodiments, network 560 may include the Internet or one or more intranets, landline networks, wireless networks, and/or other appropriate types of networks. Thus, network 560 may correspond to small scale communication networks, such as a private or local area network, or a larger scale network, such as a wide area network or the Internet, accessible by the various components of system 500.

### Example Work Flows

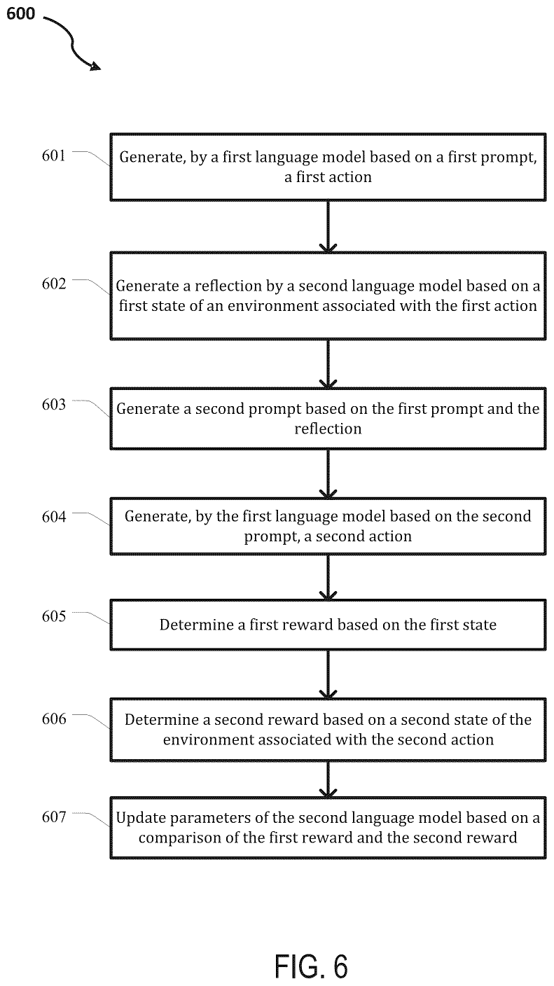

FIG. 6 is an example logic flow diagram illustrating a method of predicting a sequence of actions by a neural network based language model based on the framework shown in FIGS. 1-3, according to some embodiments. One or more of the processes of method 600 may be implemented, at least in part, in the form of executable code stored on non-transitory, tangible, machine-readable media that when run by one or more processors may cause the one or more processors to perform one or more of the processes. In some embodiments, method 600 corresponds to the operation of the AI agent module 430 (e.g., FIGS. 4A and 5) that performs action predictions.

As illustrated, the method 600 includes a number of enumerated steps, but aspects of the method 600 may include additional steps before, after, and in between the enumerated steps. In some aspects, one or more of the enumerated steps may be omitted or performed in a different order.

At step 601, a system (e.g., user device 510, server 530, or computing device 400) generates, by a first language model (e.g., actor LM 106) based on a first prompt, a first action. In some embodiments, the first prompt is based on a task instruction received via a user interface.

At step 602, the system generates a reflection (e.g., reflection response 114) by a second language model (e.g., retrospective LM 102) based on a first state of an environment (e.g., environment 108) associated with the first action. In some embodiments, generating the reflection is further based on the first action. In some embodiments, the environment is a website interface. For example, the environment may be an e-commerce website interface, and the first action may be associated with making a purchase.

At step 603, the system generates a second prompt based on the first prompt and the reflection.

At step 604, the system generates, by the first language model based on the second prompt, a second action.

At step 605, the system determines a first reward based on the first state. In some embodiments, determining the first reward comprises receiving a reward indication from a user interface device.

At step 606, the system determines a second reward based on a second state of the environment associated with the second action.

At step 607, the system updates parameters of the second language model based on a comparison of the first reward and the second reward. In some embodiments, the system keeps all parameters of the first language model frozen while updating parameters of the second language model.

### Example Results

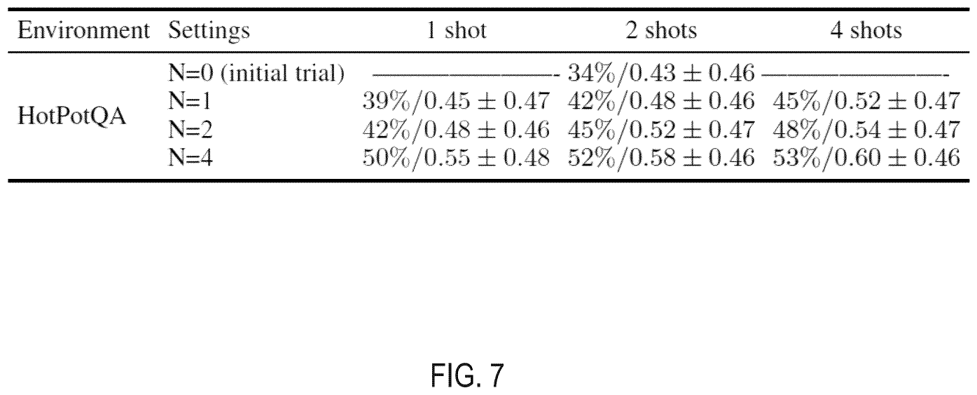

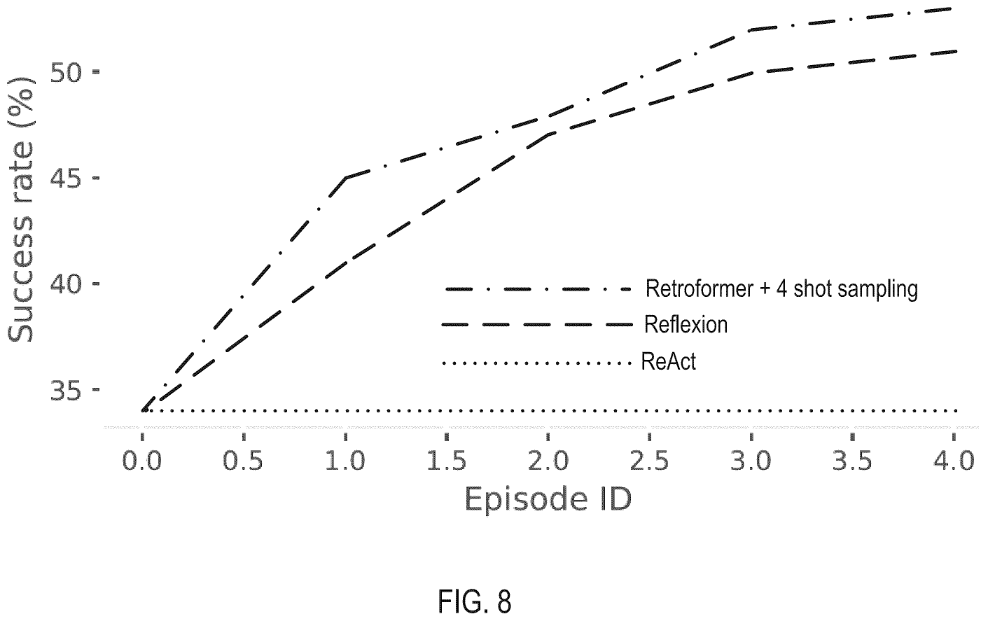

FIGS. 7-8 represent exemplary test results using embodiments described herein. Two alternative AI agent models were used for comparison. One model is Reflexion as described in Shinn et al., Reflexion: Language agents with verbal reinforcement learning, arXiv: 2303.11366, 2023. The other model is ReAct as described in Yao et al., ReAct: Synergizing reasoning and acting in language models, International Conference on Learning Representations (ICLR), 2023.

The datasets used in the experiments was HotPotQA as described in Yang et al., HotpotQA: A dataset for diverse, explainable multi-hop question answering, Conference on Methods in Natural Language Processing (EMNLP), 2018. HotPotQA consists of search-based question answering tasks to evaluate an agent's tool usage abilities under large state-action space. At each time step, the AI agent is asked to choose from three action types or API calls: Search [Entity], Lookup [Keyword], or Finish [Answer].

FIG. 7 illustrates the performance of an embodiment of the “Retroformer” AI agent framework described herein on the HotPotQA dataset. The table in FIG. 7 illustrates the success rate and average reward in N trials and best-of-n shots reflection sampling scored by the learned reward model in HotpotQA environment. F1 score grading is illustrated as the reward function to evaluate the alignment of the generated output with the expected answer. The standard deviation is calculated for the average F1 scores over 100 tasks.

FIG. 8 illustrates the performance of an embodiment of the “Retroformer” AI agent framework compared against two baseline models (Reflexion and ReAct). As shown in FIG. 4, Retroformer outperforms the two baselines. Specifically, the results indicate that the reinforced model provides the language agents with better reflection responses in early trials, which enables the agents to learn faster, while also achieving better performances in the end. Retroformer achieved 53% success rate in 5 trials, which is better than a reported 50% success rate than an alternative method which utilized a much larger language model.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of training a neural network based agent, the method comprising:
generating, by a first neural network based language model based on a first prompt describing a target task, a first action towards completing the target task in an environment;
generating, by a second neural network based language model, a reflective text associated with the first action based on a resulting first state of the environment after performing the first action on the environment, wherein the reflective text is indicative of at least one of a problem with the first action or a suggestion associated with determining actions;
generating a second prompt based on the first prompt and the reflective text;
generating, by the first neural network based language model based on the second prompt, a second action; and
updating parameters of the second neural network based language model based on a comparison of a first reward generated based on the first state and a second reward generated based on a resulting second state of the environment after performing the second action.

2. The method of claim 1, wherein the generating the reflective text is further based on the first action.

3. The method of claim 1, further comprising keeping all parameters of the first neural network based language model frozen while updating parameters of the second neural network based language model.

4. The method of claim 1, wherein the environment is a website interface.

5. The method of claim 4,
wherein the environment is an e-commerce website, and
wherein the first action is associated with making a purchase.

6. The method of claim 1, wherein determining the first reward comprises receiving a reward indication from a user interface device.

7. The method of claim 1, wherein the first prompt is based on a task instruction received via a user interface device.

8. A system for training a neural network based agent, the system comprising:
a memory that stores a first neural network based language model, a second neural network based language model, and a plurality of processor executable instructions;
a communication interface that receives a target task; and
one or more hardware processors that read and execute the plurality of processor-executable instructions from the memory to perform operations comprising:
generating, by the first neural network based language model based on a first prompt describing the target task, a first action towards completing the target task in an environment;
generating, by the second neural network based language model, a reflective text associated with the first action based on a resulting first state of the environment after performing the first action on the environment, wherein the reflective text is indicative of at least one of a problem with the first action or a suggestion associated with determining actions;
generating a second prompt based on the first prompt and the reflective text;
generating, by the first neural network based language model based on the second prompt, a second action; and
updating parameters of the second neural network based language model based on a comparison of a first reward generated based on the first state and a second reward generated based on a resulting second state of the environment after performing the second action.

9. The system of claim 8, wherein the generating the reflective text is further based on the first action.

10. The system of claim 8, the operations further comprising keeping all parameters of the first neural network based language model frozen while updating parameters of the second neural network based language model.

11. The system of claim 8, wherein the environment is a website interface.

12. The system of claim 11,
wherein the environment is an e-commerce website, and
wherein the first action is associated with making a purchase.

13. The system of claim 8, wherein determining the first reward comprises receiving a reward indication from a user interface device.

14. A non-transitory machine-readable medium comprising a plurality of machine-executable instructions which, when executed by one or more processors, are adapted to cause the one or more processors to perform operations comprising:
generating, by a first neural network based language model based on a first prompt describing a target task, a first action towards completing the target task in an environment;
generating, by a second neural network based language model, a reflective text associated with the first action based on a resulting first state of the environment after performing the first action on the environment, wherein the reflective text is indicative of at least one of a problem with the first action or a suggestion associated with determining actions;
generating a second prompt based on the first prompt and the reflective text;
generating, by the first neural network based language model based on the second prompt, a second action; and
updating parameters of the second neural network based language model based on a comparison of a first reward generated based on the first state and a second reward generated based on a resulting second state of the environment after performing the second action.

15. The non-transitory machine-readable medium of claim 14, wherein the generating the reflective text is further based on the first action.

16. The non-transitory machine-readable medium of claim 14, the operations further comprising keeping all parameters of the first neural network based language model frozen while updating parameters of the second neural network based language model.

17. The non-transitory machine-readable medium of claim 14, wherein the environment is a website interface.

18. The non-transitory machine-readable medium of claim 17,
wherein the environment is an e-commerce website, and
wherein the first action is associated with making a purchase.

19. The non-transitory machine-readable medium of claim 14, wherein determining the first reward comprises receiving a reward indication from a user interface device.

20. The non-transitory machine-readable medium of claim 14, wherein the first prompt is based on a task instruction received via a user interface device.
